(19) United States
(12) Patent Application Publication
(10) Pub. No.: US 2024/0212472 A1
(43) Pub. Date: Jun. 27, 2024

(54) SYSTEM AND METHOD FOR RESCUING A PERSON BURIED ALIVE

(71) Applicant: Maayan OTMAZGIN, HAIFA (IL)

(72) Inventor: Maayan OTMAZGIN, HAIFA (IL)

(21) Appl. No.: 18/544,522

(22) Filed: Dec. 19, 2023

(30) Foreign Application Priority Data
Dec. 27, 2022 (IL) 299555

(51) Int. Cl. G08B 21/02; A62B 33/00; G08B 25/00

(52) U.S. Cl. CPC G08B 21/02; A62B 33/00; G08B 25/00

(57) ABSTRACT

A system and method for rescuing a person buried alive, the system including a life sensor disposed inside a burial space for detecting presence of a living human person in the burial space, an oxygen container having an outlet into the burial space, an alarm to be activated upon detecting by the life sensor a living person, and a control unit adapted to perform, upon detection of human living by the life sensor, one or more of enabling the oxygen container to release oxygen into the burial space, and activating the alarm.

### FIELD

The invention relates to the field of life saving of people that were mistakenly buried while being alive.

### BACKGROUND

Alive burial can occur, among other reasons, as a result of misdiagnosing a person as dead even though he is still alive. Such horrible cases have happened in the past.

Death as a result of being buried alive is a terrible death. A buried alive person may leave scratch marks on the coffin as evidence of the horrible death he experienced.

One of the attempts to solve this problem was made by determining the depth of the coffin/burial space so that a buried person could extricate himself from the grave.

Another attempt to solve this problem was made by determining the depth of the burial space so that the buried could be extracted from the grave, or at least raze his hand to protrude out of the ground.

It is an object of the invention to provide a solution to the above-mentioned and other problems of the prior art.

Other objects and advantages of the invention will become apparent as the description proceeds.

### SUMMARY

In one aspect, the invention is directed to a system for rescuing a person buried alive, the system comprises: a life sensor (17), disposed inside a burial space (25), for detecting presence of a living human person in the burial space; an oxygen container (13) having an outlet into the burial space (25); and an alarm (15) to be activated upon detecting by the life sensor (17) a living person; a control unit (12) adapted to perform upon detection of human living by the life sensor (17) the operation of: (a) enable the oxygen container (13) to release oxygen into the burial space and (b) activate the alarm.

According to embodiments of the invention, the alarm (15) is adapted to play a siren sound or other alerting sound upon activation.

According to embodiments of the invention, the alarm (15) is adapted to display a blinking light upon activation.

The system may be further adapted to send an alert to a remote telephone of a recipient upon detecting a living person in the burial space.

According to embodiments of the invention, the recipient is a rescuing center, e.g., an institute that handles such cases, sends rescuing teams to the grave, informs local organizations of such case, and so on.

According to embodiments of the invention, the recipient is a relative of the buried person.

According to embodiments of the invention, the alert includes information of the geographical location in which the person is buried, such as predefined information, information obtained by a GPS. The predefined information may be the location of the grave in a graveyard. And when the information of the location is obtained via a GPS, it may be its geographical coordinates. The row and column of the grave in the graveyard may be detected from the geographical coordinates.

The system may be further adapted to send an alert message to an email recipient or a messaging recipient, such as WhatsApp subscriber.

Preferably, the system comprises a button or handle disposed in the burial space, for manually activating the alarm by the buried person.

Preferably, the life sensor (17) is based on analyzing micro movements of said person.

According to embodiments of the invention, the life sensor (17) detects patterns of a living human breathing in signal sensed by the life sensor.

According to embodiments of the invention, the sensed signal is an audio signal.

According to embodiments of the invention, the burial space is of a coffin (11).

According to embodiments of the invention, the burial space is confined by bricks according to a Jewish tradition.

In another aspect, the invention is directed to a method for rescuing a person buried alive in a burial space, the method comprising the steps of: for at least a period in which a person buried alive can live, sensing a signal upon which a living or death of said person is detectable; upon detecting in said sensing that said berried person is alive, generating an alert thereof and flowing oxygen into said burial space.

According to embodiments of the invention, the sensing is based on analyzing micro movements of said person.

According to embodiments of the invention, the sensing is of a signal containing a pattern characterizing living human breathing.

According to embodiments of the invention, the alert is performed by a device installed in or near the burial space.

According to embodiments of the invention, the alert is sent to a remote recipient via a network.

According to embodiments of the invention, the network is a telephone network, the internet, and so on.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments, features, and aspects of the invention are described herein in conjunction with the following drawings:

FIG. 1 schematically illustrates a gravestone and a coffin, according to embodiments of the invention.

FIG. 2 schematically illustrates a system for rescuing a buried person upon returning to life, according to embodiments of the invention.

Each of FIGS. 3a, 3b and 3c schematically illustrates an open coffin 11 in which are installed two life sensors 11, according to embodiments of the invention.

FIG. 4 is a zoomed view of a control unit, according to embodiment of the invention.

FIG. 5 is a block diagram schematically illustrating a system for rescuing a buried person upon returning to life, according to embodiments of the invention.

It should be understood that the drawings are not necessarily drawn to scale.

### DETAILED DESCRIPTION

The invention will be understood from the following detailed description of embodiments, which are meant to be descriptive and not limiting. For the sake of brevity, some well-known features, methods, systems, procedures, components, circuits, and so on, are not described in detail.

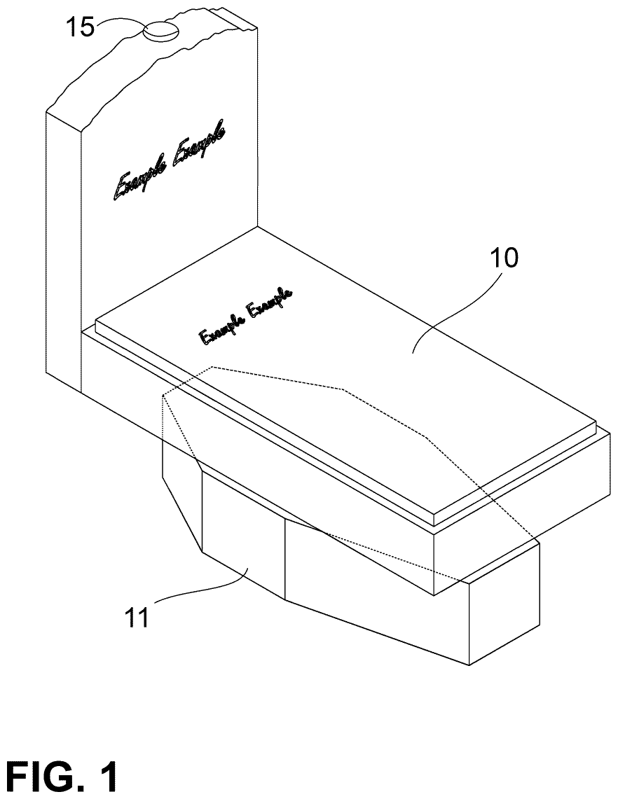

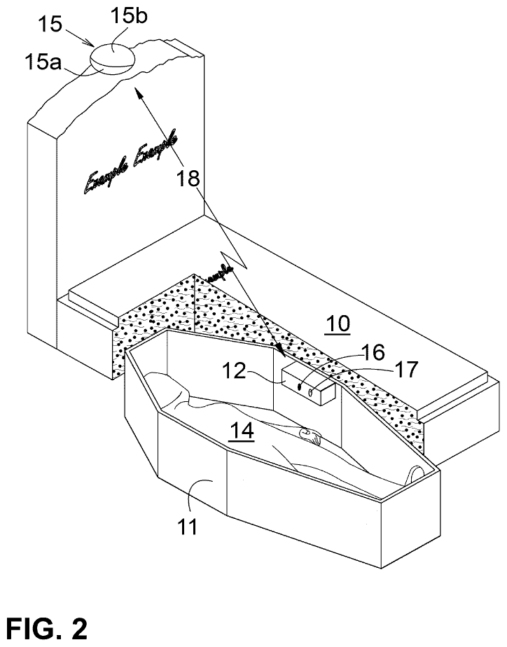

FIG. 1 schematically illustrates a gravestone and a coffin, according to embodiments of the invention.

The gravestone is marked by reference numeral 10, and the coffin is marked by reference numeral 11. The hidden lines of the coffin are drawn in dashed line.

Reference numeral 15 denotes an alarm which sounds and/or blinks upon detecting presence of a living person in the coffin.

It should be noted that according to a Jewish tradition, no coffin is used. However, the burial space is confined by bricks.

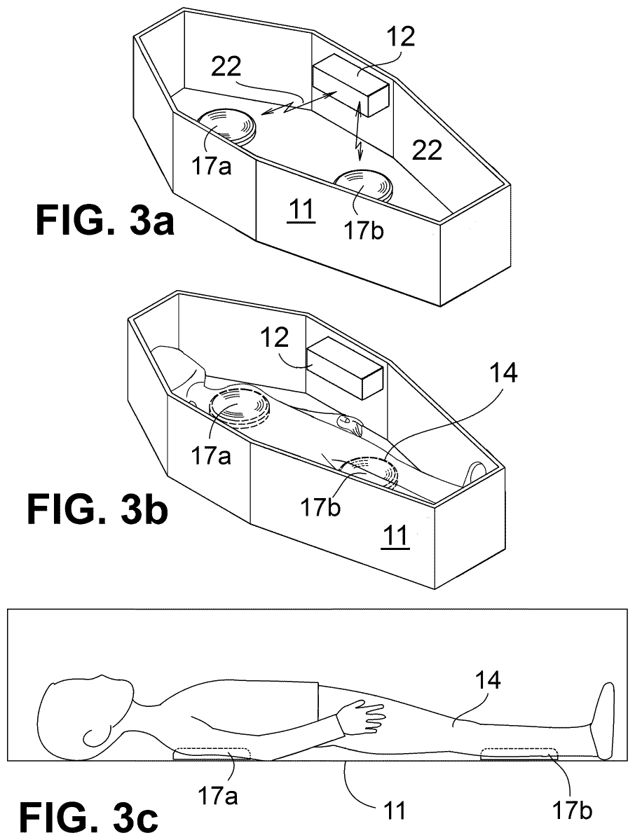

FIG. 2 schematically illustrates a system for rescuing a buried person upon returning to life, according to embodiments of the invention.

The gravestone 10 is a sectioned in order to show the coffin. The lid of the coffin is not shown, in order to show the content of the coffin.

The berried person is marked by reference numeral 14. In the coffin 11 is disposed a control unit 12 and an oxygen container 13.

An alarm 15 is disposed outside the burial space. In this illustration the alarm is disposed on the gravestone 10. The control unit 12 communicates with the alarm 15 preferably via wireless communication 18.

The control unit 12 contains a life sensor 17 and a button 16 disposed in the burial space. The alarm is activated once the life sensor detects living signs or by manual activation by pressing button 16 by a buried person.

The life sensor 17 is a sensor that detects presence of a living person nearby. The detection may be carried out, for example, by diagnosing breathing.

FIG. 3a pictorially illustrates an open coffin 11 in which are installed two life sensors 11, according to embodiments of the invention.

FIG. 3b illustrates the coffin of FIG. 3a, in which a person 14 is buried. The dash lines denote hidden lines.

FIG. 3c is a sectional view of the coffin 11 of FIG. 3b.

The sensors 17a and 17b communicate with the control unit 12 via wireless communication 22 or by wired communication. The wires of the wired communication are not shown. The wireless communication is shown only in FIG. 3a and illustrated by broken arrows 22.

As illustrated, under the person are placed two life sensors 17a and 17b, which sense micro movements of the buried person. The use of two life sensors provides better detection of presence of a living person, as each is placed under a different area of the buried person.

“Babysense” is an apparatus for detection of respiratory cessation (apnea) in babies. It constantly monitors baby's breathing micro movements through a mattress during sleep and generates an alert if breathing stops or becomes irregularly slow. The sensor is placed under the mattress. This technology may be used also for detecting living signs inside a coffin. While Babysense detects irregular and cease of breathing, according to the invention the sensor detects any movement of the buried person.

Additionally or alternatively, the detection of breathing may be carried out by detecting a pattern characterizing a breathing of a human being inside the coffin.

Once living signs are detected inside a coffin, the control unit opens a valve (solenoid) that lets oxygen of the oxygen container 13 to exit out of the container into the burial space, thereby allowing the buried individual to breath.

Additionally, the control unit sends to the alarm an instruction to activate the audio and video alerting signals. This attracts the attention of nearby individuals that a living person is buried in this grave and allows them to extract him out of the coffin.

Additionally, the rescuing system sends an alert signal to a rescuing center. The alert signal may be in a form of an audio telephone call, a text message such as SMS (Short Messaging System) message, email message, and actually any other electronic message. The call/message can be also to a telephone number of the buried person's relatives.

The alarm signal and destination thereof can be defined in the control unit.

Preferably, the system allows to a user to define in the control unit a delay (e.g., of 30 minutes) after which the rescuing system will start to operate. This way, the rescuing system starts to operate after the burial, when no interfering signals are sensed.

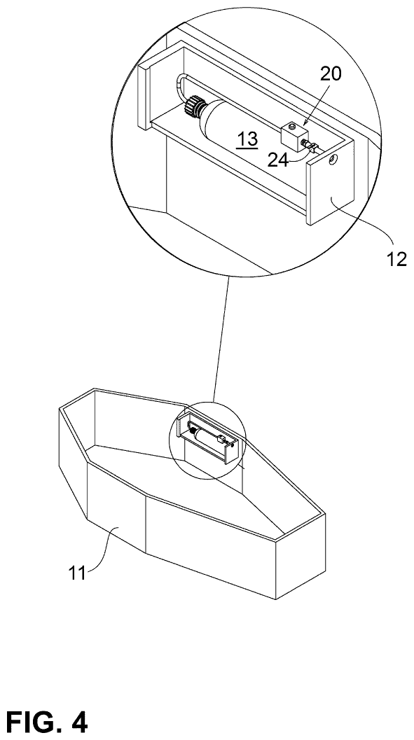

FIG. 4 is a zoomed view of a control unit, according to embodiment of the invention.

The control unit is marked herein by reference numeral 12. It comprises a processing unit 20 (which is detailed hereinafter, and not seen in this figure), an oxygen container 13 and a solenoid 24. Upon detecting presence of a living person in the burial space of coffin 11, the processing unit 20 opens solenoid 24, and oxygen from container 13 enters into the burial space of the coffin.

For the sake of clarity, the rest of the components of the control unit are not illustrated in this figure.

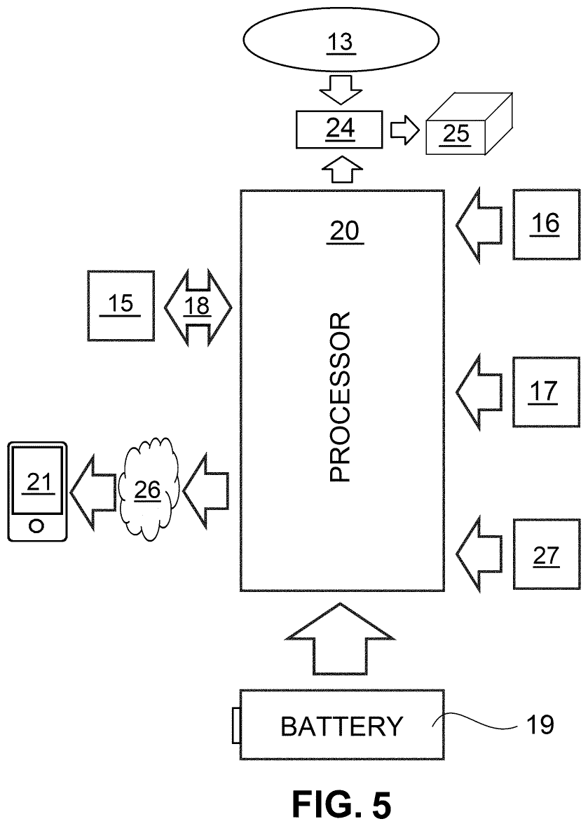

FIG. 5 is a block diagram schematically illustrating a system for rescuing a buried person upon returning to life, according to embodiments of the invention.

The “heart” of the system is a processor 20, which is an integrated electronic circuit, which receives input from the life sensor 17, analyses it for detection of human living signs, and if such signs are detected, it activates an alert.

The alert may comprise audio and visual display in the vicinity of the grave, in order to attract attention of nearby people. It also may comprise a mechanism for informing remote organizations and individuals thereabout via, for example, the telephone network and the internet.

According to further embodiments of the invention, upon receiving an alert on a buried person that is alive, the telephone company detects telephone subscribers that are present nearby, and sends them a request (e.g., by an audio message or text/graphical message) asking them to help to rescue the buried individual. Accordingly, the system comprises information about the number of the grave, such as its row and column in the graveyard. Additionally or alternatively, the rescuing system employs a GPS (Geographical Positioning System) detector disposed in/on the grave, in order to detect the coordinates of the grave.

Numeral 17 denotes a life sensor, i.e., a sensor that detects presence of a living person in its vicinity. As mentioned, such sensor may be based on the Babysense product.

Another example of a life sensor comprises a microphone that samples audio signals, and analyzing means (whether a built-in mechanism or a processor 20) in order to detect breathing patterns in the sampled audio signal.

Upon detection by the processor 20 that a live person is buried in the grave, processor 20 instructs the solenoid 24 to open in order to allow flow of oxygen into the burial space 25.

Referring to the figure, reference numeral 16 denotes a button and the like for manually activating the alert. Thus, if from any reason the rescuing system does not detect presence of a living person and accordingly does not activate the alert, the buried person may activate the alert manually.

The rescuing system may comprise a variety of alerting means, near the grave or remotely. An essential alerting device is alarm 15, which may be embodied by a loudspeaker 15a to play a siren sound and the like, and/or a blinking light fixture 15b (seen in FIG. 2).

Preferably, the communication 18 between the processor 20 and the alarm 15 is wireless, although the communication can be also wired.

Another essential alerting means sends via a network 26 a text/voice/video message to a smartphone/telephone 21 of predetermined recipients and/or other telephone subscribers present nearby. The network may be a telephone network, internet, and so on.

A battery 19 provides electric power to the processor 20 and the devices connected thereto.

The rescuing system may be designed to start to operate about tens of minutes after being activated in order to spare the analysis of the noises when the grave is open, and designed to turn off after a predetermined period, such as a week, since afterwards there is no probability that the buried person still alive.

The rescuing system may comprise storage (not illustrated) for storing information of the location of the grave (such as row number and column number), in order to be included in the message transmitted to the recipients upon detecting a living person in the grave. Additionally or alternatively, the location of the grave can be obtained by the GPS detector 27.

In the figures and/or description herein, the following reference numerals (Reference Signs List) have been mentioned:
numeral 10 denotes a gravestone;
numeral 11 denotes a coffin;
numeral 12 denotes a control unit;
numeral 13 denotes an oxygen container; —
numeral 14 denotes a berried person;
numeral 15 denotes an alarm;
numeral 16 denotes a button;
numeral 17 denotes a life sensor;
numeral 18 denotes wireless communication; —
numeral 19 denotes a battery providing power source or alternative power source;
numeral 20 denotes a processor;
numeral 21 denotes a smartphone, telephone, and the like;
numeral 22 denotes wireless communication between the sensors and the control unit;
numeral 24 denotes a solenoid;
numeral 25 denotes a burial space;
numeral 26 denotes a network such as a telephone network, the internet, and so on; and
numeral 27 denotes a GPS detector.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A system for rescuing a person buried alive, the system comprises:
a life sensor, disposed inside a burial space, for detecting presence of a living human person in said burial space;
an oxygen container having an outlet into said burial space;
an alarm to be activated upon detecting by said life sensor a living person; and
a control unit adapted to perform, upon detection of human living by said life sensor, one or more of
a) enabling said oxygen container to release oxygen into said burial space, and
b) activating said alarm.

2. The system according to claim 1, wherein said alarm is adapted to play a siren sound or other alerting sound upon activation.

3. The system according to claim 1, wherein said alarm is adapted to display a blinking light upon activation.

4. The system according to claim 1, further adapted to send an alert to a remote telephone of a recipient upon detecting a living person in said burial space.

5. The system according to claim 4, wherein said recipient is a rescuing center.

6. The system according to claim 4, wherein said recipient is a relative of said buried person.

7. The system according to claim 4, wherein said alert includes information of the geographical location in which said person is buried, wherein said information is selected from a group consisting of: predefined information, information obtained by a GPS.

8. The system according to claim 1, further adapted to send an alert message to an email or a messaging recipient.

9. The system according to claim 1, further comprising a button or handle disposed in said burial space, for manually activating said alarm by said buried person.

10. The system according to claim 1, wherein said life sensor analyses micro movements of said person.

11. The system according to claim 1, wherein said life sensor detects a pattern of a living human breathing in a sound sensed by said life sensor.

12. The system according to claim 11, wherein said sensed signal is audio signal.

13. The system according to claim 1, wherein said burial space is of a coffin.

14. The system according to claim 1, wherein said burial space is confined by bricks according to a Jewish tradition.

15. A method for rescuing a person buried alive in a burial space, the method comprising the steps of:
for at least a period in which a person buried alive can live, sensing a signal upon which a living or death of said person is detectable; and
upon detecting by said sensing that said berried person is alive, generating an alert thereof and flowing oxygen into said burial space.

16. The method according to claim 15, wherein said sensing is carried out by analyzing micro movements of said person.

17. The method according to claim 15, wherein said sensing is of a signal that contains a pattern characterizing living human breathing.

18. The method according to claim 15, wherein said alert is performed by a device installed in or near said burial space.

19. The method according to claim 15, wherein said alert is sent to a remote recipient via a network.

20. The method according to claim 19, wherein said network is a telephone network or the Internet.
